(19) United States
(12) Patent Application Publication
(10) Pub. No.: US 2008/0029548 A1
(43) Pub. Date: Feb. 7, 2008

(54) Fabric treatment dispensing package

(76) Inventors: Ann De Wree, Oost-Vlaanderen (BE); Mehmet Tugrul Ergelen, Cincinnati, OH (US); Filip Dominique Hubert Vangeel, Vilvoorde (BE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/799,793

(22) Filed: May 3, 2007

Related U.S. Application Data
(60) Provisional application No. 60/797,975, filed on May 5, 2006.

(51) Int. Cl. B67D 5/64; B67D 5/06; B65D 37/00; B65D 35/38

(52) U.S. Cl. 222/212; 222/494; 222/179.5; 222/173; 222/185.1

(57) ABSTRACT

The present invention is directed to dispensing packages for fabric treatment compositions, such as bottom dispensing packages for flowable compositions.

### CROSS REFERENCE TO RELATED APPLICATION

This application claims the benefit of U.S. Provisional Application Ser. No. 60/797,975, filed May 5, 2006.

### FIELD OF THE INVENTION

The present invention relates to dispensing packages for compact fluid laundry detergent compositions.

### BACKGROUND OF THE INVENTION

Fluid laundry products, such as liquids and gel forms of such laundry products, are sought after by many consumers for their convenience and flexibility in use. For example unlike any of: commercial unit dose detergents in soluble pouches, tablet form detergents and granule form detergents, the packaged fluid liquid or gel forms of laundry detergent if suitably packaged, e.g., not as the unit dose products, can be used flexibly according to consumers need. For instance they can be used for directly pretreating stains; and/or they can be used in the dispensing drawer of a washing machine without making a mess; and/or they can be added directly to soiled clothing in the drum of a washing machine.

Many consumers increasingly seek to conserve resources and eliminate waste. In certain countries, disposing of bulky waste packaging, e.g., plastic containers such as detergent bottles, requires troublesome recycling steps such as waste sorting, and is costly and inconvenient for the consumer.

Consequently, concentrated or so-called compact fluid laundry products which involve an overall reduction in the amount of packaging materials would be highly desirable. Suitably, compact products for the present purposes would reduce the volume of a typical dose of fluid laundry detergent down to about one half to one third of currently used doses of non-compact domestic heavy duty laundry liquids while maintaining the aforementioned flexibility in use.

Solving the problem of providing an article of commerce comprising a compact, especially a viscous compact fluid laundry detergent, and a suitable dispensing container is technically challenging. However, known packaging for viscous liquids are unsuitable for compact, especially a viscous compact fluid laundry detergents. Moreover, if a compact fluid laundry detergent were offered to consumers, they would seek reassurance that they are not wastefully using the concentrated detergent.

Consequently, the need remains for a dispensing package system for a flowable compact laundry detergent having the form of a liquid or a gel, which would save packaging materials, work properly and reliably to deliver smaller doses of the detergent without mess, would be flexible in use, would be economical, and would provide reassurance to the consumer that the detergent is being dosed correctly and not being wasted. It would be especially desirable for such a package system to perform effectively with viscous, including shear-thinning or non-newtonian forms of such laundry detergent.

### SUMMARY OF THE INVENTION

One aspect of the invention relates to a bottom dispensing package for a flowable composition comprising:

(a) a deformable container for storing the flowable composition, the container having a bottom end and an opening in the bottom end;

(b) a dispensing cap, removably attached to the bottom end of the deformable container and covering at least the opening in the bottom end; and wherein the flowable composition is a fabric treatment composition.

Another aspect of the invention relates to a bottom dispensing package comprising:

(i) a deformable container having an inner cavity for storing a flowable composition, the container having a dispensing end, comprising a base for supporting the container in an upright position and a dispensing opening for dispensing the flowable composition from the inner cavity;

(ii) a valve positioned relative to the dispensing opening for regulating the flow of the flowable composition from the inner cavity, the valve having an opened position and a closed position; in the opened position, the valve allowing the flowable composition to flow from the inner cavity through the dispensing opening for discharge, and in the closed position, the valve prohibiting the flow of the flowable composition from the inner cavity through the dispensing opening;

(iii) a dispensing cap for sealing the valve and for supporting the container in an upright position, the dispensing cap is removably attached to the container over the dispensing end of the container and over the dispensing opening for sealing the valve, and wherein the dispensing cap is formed of a cup-shaped member having a face and a cylindrical wall extending from the face to define an interior of the dispensing cap, the interior of said dispensing cap being sized for insertion over the dispensing end; and wherein the flowable composition is a fabric treatment composition.

### BRIEF DESCRIPTION OF THE DRAWINGS

In the accompanying drawings:

FIG. 1 is an illustrative example of a front view of one possible bottom dispensing package.

FIG. 2 is a section of the bottom dispensing package of FIG. 1.

FIG. 3 is an illustrative example of a front view of another possible bottom dispensing package.

FIG. 4 an exploded view of the bottom dispensing package of FIG. 3.

FIG. 5 is a section of the bottom dispensing package of FIG. 3 showing the valve in the closed position.

FIG. 6 is a section of the valve of the bottom dispensing package of FIG. 3.

FIG. 7 is a section of the bottom dispensing package of FIG. 3 showing the valve in the open position.

FIG. 8 is an illustrative example of the bottom dispensing package illustrated in FIG. 3 being gripped by a human hand.

FIG. 9 is an illustrative example of another bottom dispensing package.

### DETAILED DESCRIPTION OF THE INVENTION

Bottom Dispensing Package

In one embodiment, the bottom dispensing container or parts thereof may be at least partially, more specifically totally transparent or translucent. In another embodiment, the bottom dispensing container or parts thereof may be at least partially, more specifically totally opaque.

In one embodiment the bottom dispensing containers include an opening on the bottom for dispensing the liquid and actuation means for dispensing the gel detergent composition. One illustrative type of bottom dispensing containers is the so called squeeze containers. Squeeze containers are usually formed from a resiliently deformable material and have an opening that may have a valve to control the flow through the opening.

One type of useful valve is an on-off valve that is actuated by rotating the valve. Another particularly useful valve is a pressure-responsive dispensing valve that controls the flow according to a pressure difference across the valve. Such a valve can be configured to be normally closed and to assume an open configuration when the container is squeezed. Alternatively, the squeeze containers may be the so called bag in bottle containers or a so called airless bottle container.

Optional features of bottom dispensing squeeze containers include a cap to prevent loss of the liquid or gel between dispensing. Bottom dispensing containers of rigid materials having pump mechanisms are also suitable for use herein.

Bottom dispensing containers have several advantages over other packaging configurations. The container does not need to be inverted, requiring fewer user motions for dispensing and providing greater positioning and dispensing control than for containers that dispense by pouring or inverting and squeezing. Thus for example, the user does not have to rotate their wrist and wait for a viscous liquid to travel to the opening, or have trouble controlling the flow rate when the container is full as in the use of containers adapted to pour from the top. Bottom dispensing containers can also be configured to allow nearly all of the liquid to be dispensed, something usually not possible with containers having a pump on the top. Bottom dispensing containers having pressure-responsive valves also have the advantage of not requiring a separate closure mechanism.

The bottom dispensing container typically comprises; (1) a deformable container; (2) a dispensing cap; and (3) a flowable composition. Each of these is explained in more detail herein.

Illustrative examples of suitable bottom dispensing packages, deformable containers, dispensing caps, and components thereof may be found in U.S. Pat. No. 6,705,492, issued on Mar. 16, 2004 to Lowry; U.S. Pat. No. 4,969,581, issued on Nov. 13, 1990 to Seifert et al. U.S. Pat. No. 6,494,346, issued on Dec. 17, 2002 to Gross et al. U.S. Pat. No. 5,626,262, issued on May 6, 1997 to Fitten et al. U.S. Pat. No. 5,655,687, issued on Aug. 12, 1997 to Fitten et al. U.S. Pat. No. 4,728,006, issued on Mar. 1, 1988 to Drobish et al. U.S. Pat. No. 6,269,837, issued on Aug. 7, 2001 to Arent et al. U.S. Pat. No. 4,749,108, issued on Jun. 7, 1988 to Domsbusch et al. U.S. Pat. No. 6,675,845, issued on Jan. 13, 2004 to Volpenheim et al; WO 92/21569 entitled “Inverted Dispenser”, published Dec. 10, 1992 in the name of Canada Inc; WO 01/04006 entitled “Container”, published Jan. 18, 2001 in the name of Unilever; EP 21,545 published Jan. 7, 1981 in the name of The Procter and Gamble Company; and EP 811,559 published Dec. 10, 1997 in the name of Unilever.

1) Deformable Container

As used herein the term “deformable container” means a container whose shape and/or volume can be changed by the application of pressure or force to the container. A deformable container includes within its scope containers which do not return to their original shape and/or volume after the removal of the applied pressure or force. A deformable container includes within its scope, containers that at least partially, more specifically totally return to their approximate original shape and/or volume after the removal of the applied pressure or force. These deformable containers may regain their approximate original shape rapidly, slowly or any time in-between. While it on one hand it may be aesthetically pleasing for a deformable container to be able to regain its approximate original shape, it is also, desirable for the container to not regain its original shape as this can readily and easily communicate to the consumer how much flowable composition remains in the deformable container.

In one embodiment, the opening in the bottom end further comprises a valve, wherein the valve only allows the flowable composition to pass through opening when it is subjected to a pressure greater than that of the flowable composition under normal gravity. In other words, the gravitational force pushing down on the composition will not open the valve, additional force, pressure or the like, such as pressure or force applied by a consumer deliberately squeezing the deformable container, needs to be applied to dispense the flowable composition. The valve is selected so that the weight of any flowable composition held in the deformable container is insufficient to open the valve which remains in a closed configuration in the absence of any additional in pressure in and/or on the deformable container. The deformable container is thus situated upright with the valve closed, and is ready for dispensing flowable composition.

In one embodiment, the optional valve may be a slit valve, or alternatively have polymeric membrane having a small cross-slit there through and the like. In another embodiment, the optional valve may comprise any suitable material, more specifically a polymeric material. In one embodiment, the valve is selected from, natural rubber, synthetic rubber, silicone, silicone rubber, TPE (Thermoplastic elastomere) and TPV (thermoplastic vulcanizate) and combinations thereof. Typically, which ever material is selected for the optional valve it is a material that is stable or preferably inert or unreactive with respect to the flowable composition it is in contact with.

In another embodiment, the package is “bimodal.” The deformable container has a first mode of operation capable of storing the fluid material without leakage when the deformable container is subjected to unintentional external forces, such as being bumped, knocked, dropped and the like, and a second mode of operation capable of dispensing the fluid material when the deformable container is subjected to external forces intentionally applied by the user, such as being intentionally squeezed to dispense the flowable composition. The second mode of operation is capable of dispensing the fluid material through the opening in response to manually applied forces and of automatically ceasing the dispensing operation when the manually applied forces are removed.

In one embodiment, the deformable container further comprises a top end distal to the dispensing end; more specifically the top end is capable of supporting the deformable container in an upright position.

The deformable container may be made of any suitable material such as, glass, metal, polymer and the like and combinations thereof. In one embodiment, the deformable container comprises a polymeric material, although other packages such as paperboard cartons with film lining may be used. In one embodiment, the deformable container, is a polymeric material selected from polypropylene (PP), polyethylene (PE), polycarbonate (PC), polyamides (PA) polyethylene terephthalate (PET), polyvinylchloride (PVC), polystyrene (PS), and combinations thereof.

In one embodiment, the deformable container may be at least partially, more specifically totally transparent or translucent. In another embodiment, the deformable container may be at least partially, more specifically totally opaque. In another embodiment, the deformable container is substantially opaque and contains a transparent or translucent portion or window which is capable of providing information on how much flowable composition is present in the bottom dispensing package. This transparent or translucent portion or window may be of any suitable size or shape as long as it provides enough information on how much flowable composition is present in the bottom dispensing package.

The water insoluble container of the present invention may be of any form or size suitable for storing and packaging liquids for household use. For example, in one embodiment, the deformable container has a capacity of 100 ml to 3000 ml, more specifically 250 ml to 1500 ml. In one embodiment, the water insoluble container is suitable for easy handling, for example the container may have a handle or a part with such dimensions as to allow easy lifting or carrying the container with one hand.

The deformable container has an opening in its bottom end, more specifically a dispensing opening for dispensing the flowable composition from the inner cavity of the deformable container.

The opening in the deformable container may be of any size or form but, preferably will be wide enough for conveniently dosing the flowable composition. The size of the opening will depend upon many factors, for example, volume of the deformable container, size of the deformable container, viscosity of the flowable composition, flow rate of the flowable composition, the material the deformable container is made of, what the flowable composition is and the like and combinations thereof.

The deformable container may be formed by any suitable process, such as, thermoforming, blow molding, injection molding, injection-stretch blow bolding (ISBM) or the like.

In another embodiment, the deformable container may comprise a front and back on opposite sides of the deformable container.

The deformable container may be of any suitable size, shape, volume and/or footprint. The deformable container may have any suitable thickness of container walls. The deformable container may be symmetrical or asymmetrical in shape. All these variables, size, shape, volume, footprint wall thickness, symmetry and the like, will all depend upon many factors, such as, volume and/or weight of flowable composition to be contained therein, what the flowable composition is, the desired appearance of the deformable container and/or bottom dispensing package, and the like, and combinations thereof. In one embodiment, the deformable container is a bottom dispensing bottle.

In one embodiment, the deformable container has substantially uniform thickness, that is, the thickness of the walls of the deformable container are all approximately the same. In one embodiment, the deformable container includes one or more walls, which comprise one or more layers. The layers may be, if desired, very thin, e.g., less than about 0.1 mm thick and may range to and above about 10 mm in thickness.

In another embodiment, the deformable container has a shape selected from cylindrical, tubular, conical, frustum of a cone, spheroidal, cubodial, pyramidoidal, pentagonal, hexagonal, heptagonal, octagonal, and combinations thereof. In one embodiment, the deformable container is tapered.

Furthermore, the deformable containers may have a symmetrical or asymmetrical footprint. By footprint, it is intended to mean the portion or portions, of the deformable container that stably rests on a surface, typically this is the base of a deformable container, but it may be a side or even the top of the deformable container.

As also noted herein the deformable container may have any desired dimensions. In one embodiment, the deformable container has a height of from about 10 mm to about 400 mm. In another embodiment, the deformable container has a width at its widest portion of from about 10 mm to about 200 mm. In yet another embodiment, the deformable container has a length at its longest portion of from about 10 mm to about 200 mm.

In one embodiment, the deformable container is ergonomically proportioned to permit gripping and motion by a human hand when dispensing the flowable composition from the deformable container.

2) Dispensing Cap

The opening in the deformable container is covered, and may be closed by a dispensing cap which is removably attached thereto. In one embodiment the dispensing cap is releaseably attached to the bottom end of the deformable container. As used herein “removably attached” means that the dispensing cap is initially attached to the deformable container and is capable of being removed therefrom. A “removably attached” dispensing cap may be also reattached to the deformable container or it may be permanently removed from the deformable container. As used herein “releaseably attached” means that the dispensing cap is initially attached to the deformable container and is capable of being repeatedly removed therefrom and may be also repeatedly reattached to the deformable container. The term “releaseably attached” falls with in the scope of the definition of “removably attached”.

The dispensing cap may be of any form or size and may be, for example be screwed on, clicked on, or otherwise attached to the container to cover, the opening. Alternatively, the dispensing cap can be removably attached to the deformable container, whether the deformable container is open or closed. The optional closing means may also be incorporated in the container. In one embodiment, the dispensing cap further comprises a closable discharge opening that is in fluid communication with the opening in the bottom end of the deformable container.

The dispensing cap container may be made of any suitable material such as, glass, metal, polymer and the like and combinations thereof. In one embodiment, the dispensing cap comprises a polymeric material, materials such as metal, glass, cork, paperboard cartons with film lining and glass may be used. In one embodiment, the dispensing cap, is a polymeric material selected from polypropylene (PP), polyethylene (PE), polycarbonate (PC), polyamides (PA) polyethylene terephthalate (PET), polyvinylchloride (PVC), polystyrene (PS), and combinations thereof.

The dispensing cap may be of any size or form, but typically wide enough for conveniently dosing the flowable composition. The size of the dispensing cap will depend upon many factors, for example, volume of the deformable container, desired volume of dispensing cap, size of the deformable container, viscosity of the flowable composition, flow rate of the flowable composition, the material the deformable container is made of, what the flowable composition is and the like and combinations thereof.

In one specific embodiment, the dispensing cap may be of any suitable size or volume, but usually the dispensing cap will have a maximum capacity of specifically from about 1 ml to about 300 ml, more specifically from about 5 ml to about 150 ml, even more specifically from about 10 ml to about 100 ml. In one embodiment, the dispensing cap is suitable for easy handling, for example the dispensing cap may have a handle or a part with such dimensions as to allow easy lifting or carrying the dispensing cap with one hand.

The dispensing cap may be formed by any suitable process, such as, thermoforming, blow molding, injection molding, injection-stretch blow bolding (ISBM) or the like.

The dispensing cap may be of any suitable size, shape, volume and/or footprint, as well as having any suitable thickness of container walls. The dispensing cap may be symmetrical or more specifically asymmetrical. These variables will all depend upon many factors such as, volume and/or weight of flowable composition to be contained therein, what the flowable composition is, the desired appearance of the dispensing cap, and the like.

In one embodiment, the dispensing cap is capable of supporting the deformable container in an upright position.

In one embodiment, the dispensing cap has substantially uniform thickness, that is, the thickness of the walls of the dispensing cap are all approximately the same. In one embodiment, the dispensing cap includes one or more walls, which comprise one or more layers. The layers may, if desired, be very thin, e.g., less than about 0.1 mm thick and may range to and above about 10 mm in thickness.

In another embodiment, the dispensing cap has a shape selected from cylindrical, tubular, conical, frustum of a cone, spheroidal, cubodial, pyramidoidal, pentagonal, hexagonal, heptagonal, octagonal, and combinations thereof. In one embodiment, the dispensing cap is the same or similar shape as the deformable container, for example, both are cylinders. In another embodiment, the dispensing cap is a different same shape than deformable container, such as, the dispensing cap is a cup shaped member where as the deformable container is a cylinder.

In one embodiment, the dispensing cap may be used as a measuring device in order for the correct amount of flowable composition to be used by a consumer in a laundry process. In another embodiment, the dispensing cap is a dosing device intended contain an amount of flowable composition and be placed in a washing machine where the dispensing cap releases the flowable composition contained therein at the desired or appropriate rate and at the desired or appropriate time.

In another embodiment, the dispensing cap is provided with an anti tamper device. These anti-tamper devices provide a visual and/or audible indication if the bottom dispensing package has been opened or tampered with in some fashion. Illustrative examples of these anti-tamper devices, include: a polymeric film placed over the dispensing cap and a portion of the deformable container, such that, in order to remove the dispensing cap the polymeric film has to be removed; a pop-up feature, which makes a noise, such as a popping sound, when the dispensing cap is removed from the deformable container for the first time; a dispensing cap that separates permanently in to two portion upon opening with one portion remaining on and/or attached to the deformable container; and the like and combinations thereof.

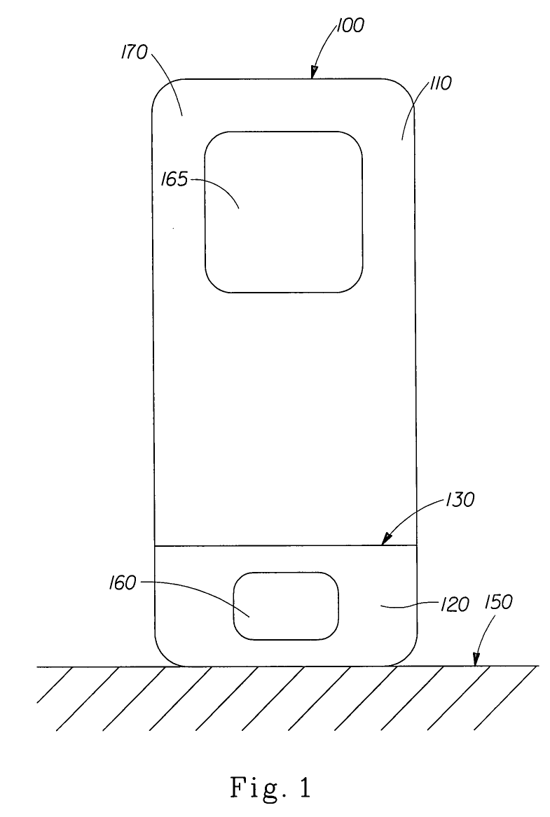

The various different and optional embodiments of the bottom dispensing package, deformable container, and/or dispensing cap may be further explained and illustrated with reference to FIGS. 1 to 9.

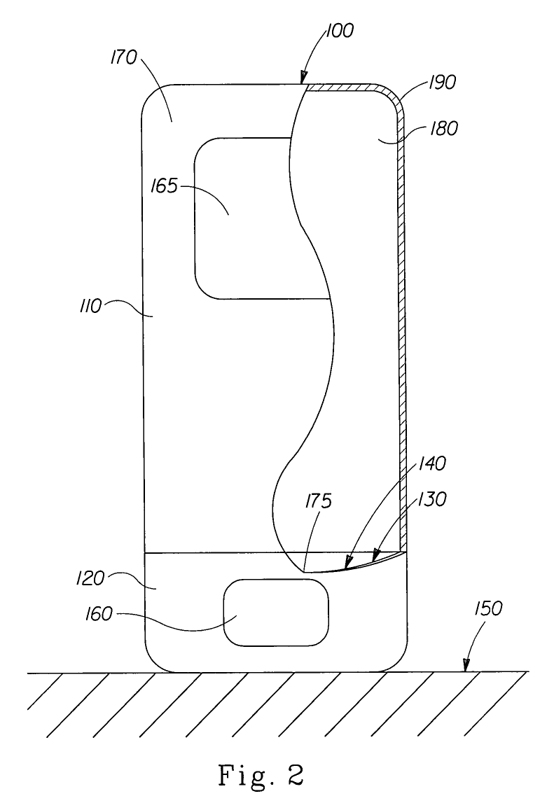

FIG. 1, is also an illustrative example of a bottom dispensing package 100, comprising a deformable container 110 and a dispensing cap 120 which is removably attached thereto. The deformable container 110 has a bottom end 130 with an opening 140 (FIG. 2) therein. The dispensing cap 120 is removably attached to the bottom end 130 of the deformable container 110 covering the opening 140. The dispensing cap 120 is also shown resting on the surface 150 in an upright position.

FIG. 1 is an illustrative example of a bottom dispensing package 100 having indicia 160 and 165 associated therewith. The indicia 160 and 165, which may be the same or different are in association with the deformable container 110 and the dispensing cap 120. In this embodiment, the indicia in association therewith 160 and 165 are two labels which are fastened to the deformable container 110 and the dispensing cap 120 via adhesive.

The deformable container 110 of FIG. 1 also has a top end 170 which is distal to the bottom end 130. The deformable container 110 is also capable of resting on the surface 150 in an upright position with top end 170 contacting the surface 150, that is, now inverted with respect to the deformable container 110 as shown in FIG. 1.

As noted previously any portion of the bottom dispensing package 100 such as the deformable container 110 and/or the dispensing cap 120 can be translucent or transparent.

FIG. 2, is a section view of one possible embodiment of the bottom dispensing package 100 of FIG. 1 along line 2 of FIG. 1. This section view shows the flowable composition 180 and the optional valve 175, through which the flowable composition 180 is dispensed. Also shown is the wall 190 of the deformable container 110.

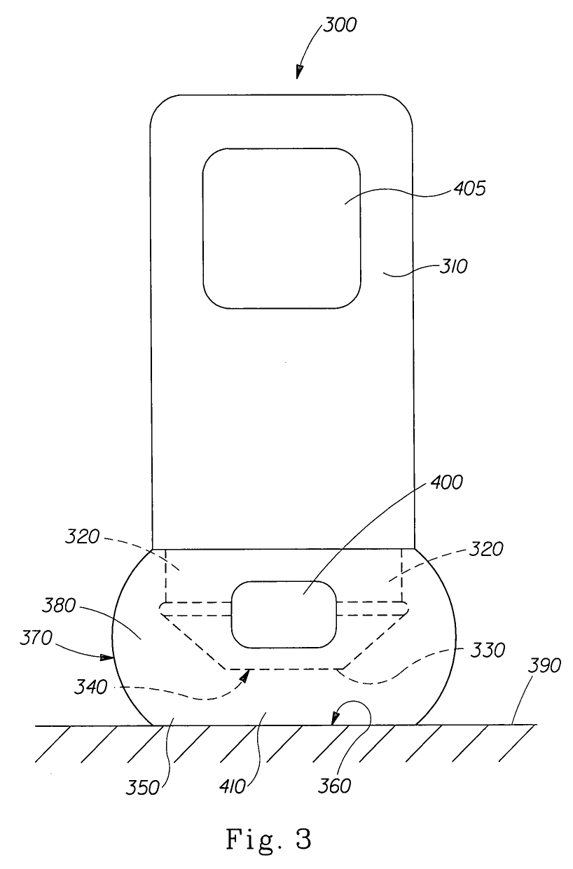

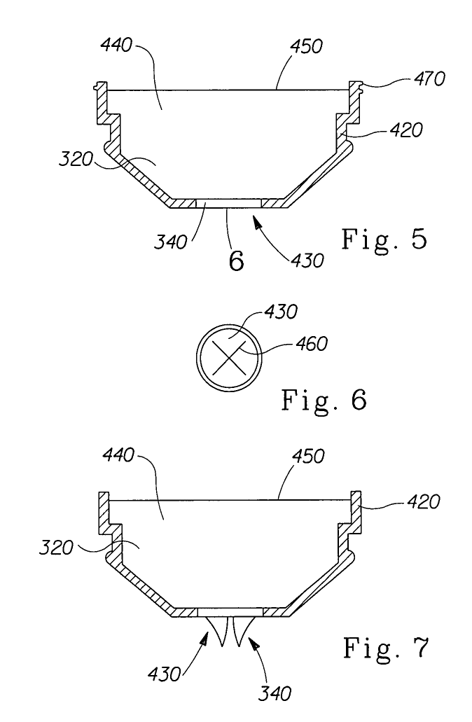

FIG. 3 is another alternative example of a bottom dispensing package 300, comprising a deformable container 310 and a dispensing cap 350 which is removably attached thereto. The deformable container 310 is attached, e.g. by snap fitting, to a dispensing end 320 having a base 330 for supporting the deformable container 310 in an upright position with a dispensing opening 340 therein. The dispensing cap 350 covers the opening 340 and the valve 430 (FIG. 5). The dispensing cap 350 supports the dispensing end 320, deformable container 310 and the bottom dispensing package 300 as a whole in an upright position. The dispensing cap 350 is removably attached to the deformable container 310 over the dispensing end 320, dispensing opening 340 and covering the valve 430 and opening 340. The dispensing cap 350 is formed of a cup shaped member 410 having a face 360 and a cylindrical wall 370 which extends from the face to define an interior 380 of the dispensing cap 350. The face 360 of the dispensing cap 350 is also shown resting on the surface 390 in an upright position. The dispensing cap 350 is capable of receiving and dispensing flowable composition 450 (FIG. 5), more specifically dispensing the flowable composition within a washing machine.

The bottom dispensing package 300 having indicia 400 and 405 associated therewith. The indicia 400 and 405, which may be the same or different are in association with the deformable container 310 and the dispensing cap 350. In this embodiment, the indicia in association therewith 400 and 405 are two labels which are fastened to the deformable container 310 and the dispensing cap 350 via adhesive.

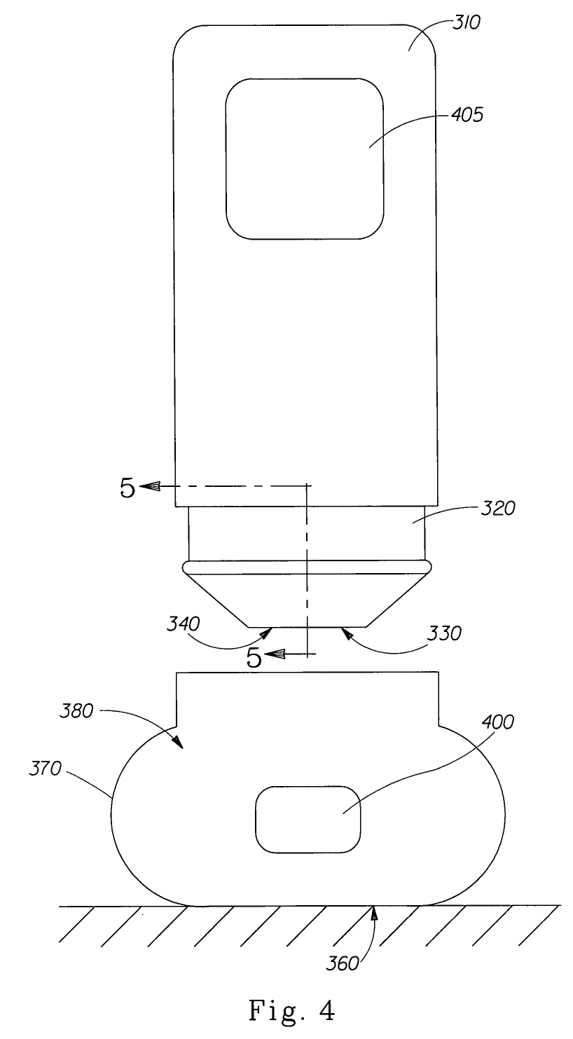

FIG. 4 is an exploded view of the bottom dispensing package 300 of FIG. 3, which shows the dispensing cap 350 as releasably attached to the deformable container 310.

FIG. 5 is a section view of one possible embodiment of the bottom dispensing package 300 of FIG. 4 along line 5. This sectional view shows the inner cavity 440 which is for storing the flowable composition 450 and the optional valve 430, through which the flowable composition 450 is dispensed. Also shown is the wall 420 of the deformable container 310. The valve 430 is shown in the closed position, such that flowable composition 450 is prevented from flowing through the dispensing opening 340.

FIG. 6 is a section view of one possible embodiment of the valve 430 of FIG. 5 along line 6. The valve 430 has a small cross slit 460 therethrough.

FIG. 7 is a section view of one possible embodiment of the bottom dispensing package 300 of FIG. 4 along line 5. The valve 430 is shown in the open position, such that flowable composition 450 is allowed to flow from the inner cavity 440 and through the dispensing opening 340.

The valve 430 in one specific optional embodiment only allows the flowable composition 450 to pass through the dispensing opening 430 when it is subjected to a pressure greater than that of the flowable composition 450 under normal gravity.

Alternatively, the valve 430 in another specific optional embodiment is a bimodal valve wherein the bimodal valve has a first mode of operation capable of retaining the flowable composition 450 without leakage when the deformable container 310 is subjected to unintentional external forces, such as can be seen illustrated in FIG. 5, and a second mode of operation capable of dispensing the flowable composition 450 when the deformable container 310 is subjected to external forces intentionally applied by a user, such as can be seen illustrated in FIG. 7.

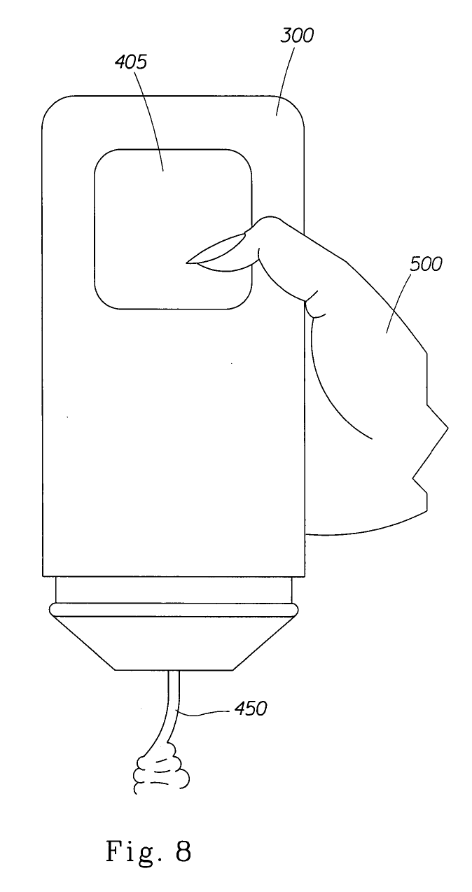

FIG. 8 is an illustrative example of the bottom dispensing package 300 of FIG. 3 being gripped by a human hand 500 and dispensing the flowable composition 450. (Note: the human hand or parts thereof, are not part of the scope of the present invention).

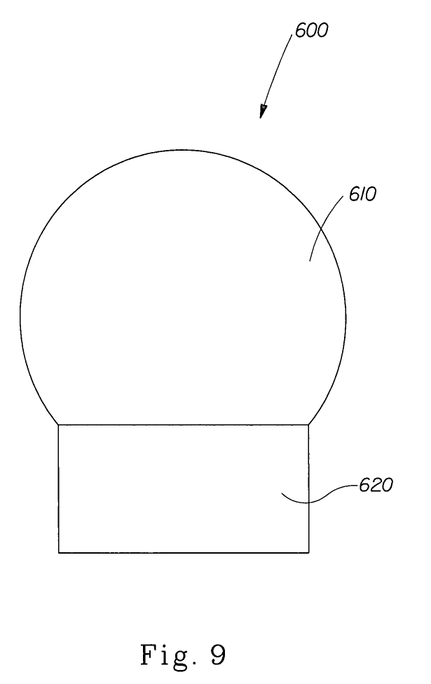

FIG. 9 is an illustrative example of another possible container. In FIG. 9, the bottom dispensing package 700 comprises a spherical deformable container 610 and a rectangular dispensing cap 620. The bottom dispensing package deformable container and dispensing cap of the present invention may be any shape.

3) Flowable Composition

In one embodiment, the flowable composition comprises a fabric treatment composition.

As used herein, “fabric treatment composition” refers to in the broadest to include any product which is typically used in the laundry or imparts a laundry benefit such as, fabric cleaning, whiteness maintenance, softening, freshness, scent, static control, absorbency, color care, and/or wrinkle control, and the like, to fabrics during the laundering process. The fabric treatment composition may be in the from of a liquid, gels, liquid-gels and the like. In one embodiment of the present invention the fabric treatment composition is selected from heavy duty liquid laundry detergent (“HDL”), light duty detergents (“LDD”), bleaching compositions, fabric softening compositions, pretreater compositions, and fabric refreshing compositions and the like and combinations thereof.

In one embodiment, the fabric treatment composition is a fabric care composition that comprises a fabric conditioning composition. By way of example, fabric conditioning compositions are described in U.S. Pat. Nos. 4,424,134; 4,767,547; 5,460,736; 5,545,340; 5,545,350; 5,562,849; 5,574,179; 5,874,396; 5,998,359; 6,020,304; 6,022,845; 6,083,899; 6,093,691; and 6,103,678. In one embodiment, compositions of the present invention comprise a fabric softening active. In one embodiment, the fabric softening active is a quaternary ammonium compound.

In another embodiment, the fabric softening active comprises a cationic starch. Suitable cationic starches are described at U.S. Pat. App. Pub. US 2004/0204337, published Oct. 14, 2004, at paragraphs 16-29. Other suitable fabric softeners actives are also described in US 2004/0204337 at paragraphs 30-79.

In another embodiment, the fabric treatment composition is a “rinse added” composition, wherein the composition is added during a rinse cycle of an automatic washing machine. In another embodiment, the fabric treatment composition is a “wash-added” composition, wherein the composition is added at the initial, wash-cycle of an automatic washing machine.

In another embodiment, fabric treatment composition is a fabric care composition that comprises a cleaning composition. The term “cleaning composition” is used herein in the broadest sense and includes laundry cleaning compositions, such as, heavy duty liquid laundry detergent compositions, light duty liquid laundry detergent compositions, laundry pretreaters, products for pre-soaking laundry, laundry additives and combinations thereof. Examples of cleaning compositions are described in U.S. Pat. Nos. 4,515,705; 4,537,706; 4,537,707; 4,550,862; 4,561,998; 4,597,898; 4,968,451; 5,565,145; 5,929,022; 6,294,514; and 6,376,445.

Additional illustrative examples of fabric treatment compositions, may be found in copending U.S. Provisional Patent Application No. ______, entitled “Compact Fluid Laundry Detergent Composition” filed on May 5, 2006 in the name of Francesco Buzzaccarini et al., Attorney Docket Number 10401P; U.S. Provisional Patent Application No. ______ entitled “Compact Fluid Laundry Detergent Composition” filed on May 5, 2006 in the name of Francesco Buzzaccarini et al., Attorney Docket Number 10402P; U.S. Provisional Patent Application No. ______ entitled “Gel Compositions Contained in Bottom Dispensing Containers” filed on May 5, 2006 in the name of Francesco Buzzaccarini et al., Attorney Docket Number 10405P; and U.S. Provisional Patent Application No. ______ entitled “Concentrated Compositions Contained in Bottom Dispensing Containers” filed on May 5, 2006 in the name of Francesco Buzzaccarini et al., Attorney Docket Number 10404P.

In one embodiment, the fabric treatment compositions may be transparent or translucent, as defined herein. In another embodiment, the fabric treatment compositions may be opaque, as defined herein.

Array of Consumer Products

One optional aspect of the present invention comprises an array of consumer products, specifically comprising at least two of the bottom dispensing packages described herein. In one embodiment, each of the bottom dispensing packages present in the array of consumer products would be different in some fashion. This difference may be the shape of the deformable container and/or dispensing cap, volume of the deformable container and/or dispensing cap, dimension of the deformable container and/or dispensing cap, color of the deformable container and/or dispensing cap, indicia in association with the deformable container and/or dispensing cap, different flowable compositions, and the like.

In one embodiment, the array is an array of laundry products, even more specifically an array of laundry products comprising an indicia in association with the at least two or more bottom dispensing packages, the indicia providing a visual indication of a relationship between the at least two or more bottom dispensing packages

In one embodiment, the array comprises one or more of the bottom dispensing packages described herein and one or more package other than the bottom dispensing packages described herein. Illustrative suitable packages other than bottom dispensing packages described herein is described in U.S. Provisional Application Ser. No. 60/541,114, filed Feb. 2, 2004, entitled “CONTAINER HAVING A HELICAL GRIP,” to Brian Floyd,; U.S. Pat. Nos. 4,550,862; and 4,981,239, U.S. Design Pat. Nos. Des. 403,578; Des. 414,421; Des. 425,792; Des. 491,071; Des. 466,816; Des. 457,064; Des. 439,520; Des. 286,602; Des. 429,643; Des. 472,151; Des. 417,622; Des. 322,748; and Des. 509,748; and in U.S. Utility Pat. Nos. 4,732,315; 6,021,926; 6,269,962; 4,846,359; 6,960,375; 6,223,945; 6,902,077; 6,824,001; 6,959,834; 6,491,165; 5,050,742; 6,705,465; 6,630,437; 6,756,350; 6,366,402; 6,159,958; and 6,601,705.

Indicia

In one embodiment, the bottom dispensing package, typically the deformable container and/or the dispensing cap has indicia in association with. As used herein, “indicia” refers to scent, branding, packaging, properties, sound, words, phrases, letters, characters, brand names, company names, company logos or symbols, descriptions, logos, icons, designs, designer names, symbols, motifs, insignias, figures, marks, signals, colors, textures, shapes, tokens, advertisements, and combinations thereof.

As used herein, “in association with” means the indicia, and the like are either directly printed on, or attached thereto the bottom dispensing package, typically the deformable container and/or the dispensing cap, or a label attached to the bottom dispensing package, typically the deformable container and/or the dispensing cap and/or are presented in a different manner including, a brochure, print advertisement, electronic advertisement, and/or verbal communication, so as to communicate the indicia to a consumer.

In one embodiment, the indicia is selected from words, phrases, brand names, company names, descriptions, perfume names, designer names, advertisements, and combinations thereof. The indicia may be in one or more than one language.

In another embodiment, one or more indicia may be printed directly on the bottom dispensing package, the deformable container and/or the dispensing cap. In another embodiment, one or more indicia may be embossed on the on the bottom dispensing package, the deformable container and/or the dispensing cap.

In one embodiment, the indicia in association with the bottom dispensing package, the deformable container and/or the dispensing cap, via a label. A label provides a convenient point-of-purchase site for the indicia and the like. The term “label” is used herein in the broadest sense to include the tangible medium that may optional contain one or more indicia, that may be expressed including, by way of illustrative example, the placing of indicia directly onto the bottom dispensing package, the deformable container and/or the dispensing cap, the printing of indicia on a substrate wherein the substrate is placed on, or associated therewith, an outside surface of the bottom dispensing package, or packaging such as boxes that enclose the bottom dispensing package, the deformable container and/or the dispensing cap. In one embodiment, an olfactory scent descriptor may also be provided via a label (e.g., packaging). For example, the label itself may be scented, i.e., comprises a scent.

The optional labels of the present invention may generally mimic the shape of the bottom dispensing package, more specifically the deformable container and/or the dispensing cap. Illustrative examples of suitable labels include partially wrap-around labels, wrap-around labels, shrink-wrap labels, stickers, in-mold labels, hang-tags, labels conveying the name of the product, and combinations thereof.

In one embodiment, the label is a clear substrate such that the indicia may be printed onto the label and the bottom dispensing package, the deformable container and/or the dispensing cap, (if the bottom dispensing package, the deformable container and/or the dispensing cap is transparent or translucent) is substantially visible by the consumer through the label where the indicia is absent. Without wishing to be bound by theory, a clear label may maximize the color of the composition or the tint of the container in communicating to the consumer.

In another embodiment, the label has a background color to further communicate to the user. For example, if the scents or scent identifiers are magnolia and orange, the label may have an orange background color to further communicate this scent experience to the user given the visual association of an orange color to orange fruit and/or orange blossoms and hence the orange scent.

In another specific optional embodiment, one or more indicia may be printed directly on the bottom dispensing package more specifically the deformable container and/or the dispensing cap. In another embodiment, one or more indicia may be embossed on the bottom dispensing package more specifically the deformable container and/or the dispensing cap.

In one optional embodiment, the label is “shrink wrapped” on the bottom dispensing package more specifically the deformable container and/or the dispensing cap. In another optional embodiment, the label is adhered to the bottom dispensing package more specifically the deformable container and/or the dispensing cap by an adhesive.

Methods of Use

The present invention also provides a method for treating fabrics. Such a method employs dispensing a portion of the flowable composition from the bottom dispensing package into a washing machine. In one embodiment, the method includes the step of step of dispensing a portion of the flowable composition from the deformable container into the dispensing cap.

Transparent or Translucent

As used herein, “translucent or transparent” refers to a transmittance of greater than about 25% transmittance of at least one wavelength of electromagnetic radiation in the visible spectrum (approx. 410-800 nm), more specifically a transmittance of more than about 25%, even more specifically more than about 30%, even more specifically still more than about 40%, yet even more specifically still more than about 50% in the visible part of the electromagnetic spectrum wherein % transmittance equals:

$$\frac{1}{{10}^{absorbancy}} \times 100 \% .$$

Alternatively, a container, composition and the like may be considered translucent or transparent if the absorbency of the bottle of the visible electromagnetic spectrum is less than about 0.6. An illustrative example of a translucent or transparent object would be a clear bottle or clear composition. Another example of a translucent or transparent object would be a bottle or composition which is colored, such having a blue or red tint, but still has a transmittance of greater than about 25% transmittance of at least one wavelength of electromagnetic radiation in the visible spectrum.

In one embodiment, the flowable composition is transparent or translucent and has a transmittance of at least about a 50% transmittance of light using a 1 cm cuvette at wavelengths of about 410 nanometers to about 800 nanometers.

Additional illustrative information and examples of translucent or transparent and opaque containers and/or compositions and the like can be found in U.S. Pat. No. 6,630,437 issued to Murphy et al. U.S. Pat. No. 6,756,350 issued to Giblin et al. U.S. Pat. No. 6,631,783 issued to Giblin et al. and U.S. Pat. No. 6,159,958 issued to Bae-Lee et al.

As used herein, “opaque” refers to a transmittance of less than about 25% transmittance of all wavelengths of electromagnetic radiation in the visible spectrum, more specifically a transmittance of less than about 20%, even more specifically less than about 15%, even more specifically still less than about 10%, yet even more specifically still less than about 5% in the visible part of the electromagnetic spectrum. Alternatively, a container, composition and the like may be considered opaque if the absorbency of the bottle of the visible electromagnetic spectrum is greater than about 0.6.

Methodology—Measurement of Absorbency and Transmittance

Instrument: Milton Roy Spectronic 601

Procedure:

1. Both the spectrophotometer and the power box were turned on and allowed to warm up for 30 minutes.

2. Set the wavelength: Type in the desired wavelength on the keypad (i.e., 590, 640, etc.). Press the [second function] key. Press the “go to λ” [yes] key. The machine is then ready to read at the chosen wavelength.

3. Zero the instrument: Press the [second function] key. Press the “zero A” [% T/AIC]. Instrument should then read “XXX NM 0.000 A T”

4. Open the cover, place sample vertically and in front of the sensor.

5. Close the lid and record reading (ex. 640 NM 0.123 A T)

Note: all readings are taken in “A” mode (absorbency mode)

Note: zero instrument with every new wavelength change and/or new sample.

Absorbency Values for Two Typical Plastic Bottles

| | Polyethylene (HDPE) | Polypropylene (PP) |
|---|---|---|
| Wavelength (in nm) | 0.960 mm thickness | 0.423 mm thickness |
| 254 (non-visible) | 1.612 | 1.886 |
| 310 (non-visible) | 1.201 | 0.919 |
| 360 (non-visible) | 0.980 | 0.441 |
| 590 (visible) | 0.525 | 0.190 |
| 640 (visible) | 0.477 | 0.169 |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. All temperatures are in degrees Celsius (° C.) unless otherwise specified.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A bottom dispensing package for a flowable composition comprising:
(a) a deformable container for storing said flowable composition, said deformable container having a bottom end and an opening in said bottom end; and
(b) a dispensing cap, removably attached to said bottom end of said deformable container and covering at least said opening in said bottom end; wherein said flowable composition is a fabric treatment composition.

2. The bottom dispensing package according to claim 1 wherein said dispensing cap further comprises a closable discharge opening that is in fluid communication with said opening in said bottom end.

3. The bottom dispensing package according to claim I wherein said opening in said bottom end further comprises a valve, wherein said valve only allows said flowable composition to pass through opening when it is subjected to a pressure greater than that of said flowable composition under normal gravity.

4. The bottom dispensing package according to claim 1 wherein said opening in said bottom end further comprises a bimodal valve, wherein said bimodal valve has a first mode of operation capable of retaining said flowable composition without leakage when said deformable container is subjected to unintentional external forces and a second mode of operation capable of dispensing said flowable composition when said deformable container is subjected to external forces intentionally applied by a user.

5. The bottom dispensing package according to claim 1 wherein said dispensing cap is releaseably attached to said bottom end of said deformable container.

6. The bottom dispensing package according to claim 5 wherein said dispensing cap is designed to receive a supply of said flowable composition from said deformable container.

7. The bottom dispensing package according to claim 1 wherein at least a portion of said deformable container is either transparent or translucent.

8. A method of treating fabric in a washing machine comprising at least the step of dispensing a portion of said flowable composition from said bottom dispensing package of claim 1 into said washing machine.

9. An array of laundry products comprising at least two of the bottom dispensing packages according to claim 1.

10. The array of laundry products according to claim 9 comprising indicia in association with said at least two or more bottom dispensing packages, said indicia providing a visual indication of a relationship between said at least two or more bottom dispensing packages.

11. A bottom dispensing package comprising:
(i) a deformable container having an inner cavity for storing a flowable composition, said container having a dispensing end, comprising a base for supporting said container in an upright position and a dispensing opening for dispensing said flowable composition from said inner cavity;
(ii) a valve positioned relative to said dispensing opening for regulating the flow of said flowable composition from said inner cavity, said valve having an opened position and a closed position; in the opened position, said valve allowing said flowable composition to flow from said inner cavity through said dispensing opening for discharge, and in the closed position, said valve prohibiting the flow of said flowable composition from said inner cavity through said dispensing opening;
(iii) a dispensing cap for sealing said valve and for supporting said container in an upright position, said dispensing cap is removably attached to said container over said dispensing end of said container and over said dispensing opening for sealing said valve, and wherein said dispensing cap is formed of a cup-shaped member having a face and a cylindrical wall extending from the face to define an interior of said dispensing cap, said interior of said dispensing cap being sized for insertion over said dispensing end; and
wherein said flowable composition is a fabric treatment composition.

12. The bottom dispensing package according to claim 11 wherein said valve is formed of a polymeric membrane having a small cross-slit therethrough, and said polymeric membrane is selected from, natural rubber, synthetic rubber, silicone rubber, and combinations thereof.

13. The bottom dispensing package according to claim 11 wherein said valve only allows said flowable composition to pass through opening when it is subjected to a pressure greater than that of said flowable composition under normal gravity.

14. The bottom dispensing package according to claim 11 wherein said valve is a bimodal valve, wherein said bimodal valve has a first mode of operation capable of retaining the flowable composition without leakage when said deformable container is subjected to unintentional external forces and a second mode of operation capable of dispensing said flowable composition when said deformable container is subjected to external forces intentionally applied by a user.

15. The bottom dispensing package according to claim 11 wherein said deformable container comprises a polymeric material.

16. The bottom dispensing package according to claim 15 wherein said polymeric material is selected from polypropylene, polyethylene, polycarbonate, polyamide, polyethylene terephthalate, polyvinylchloride, polystyrene, and mixtures thereof.

17. The bottom dispensing package according to claim 11 wherein said dispensing cap is selected from metal, polymeric material and mixtures thereof

18. The bottom dispensing package according to claim 17 wherein said polymeric material is selected from polypropylene, polyethylene, polycarbonate, polyamide, polyethylene terephthalate, polyvinylchloride, polystyrene, and mixtures thereof.

19. A method of treating fabric in a washing machine comprising at least the step of dispensing a portion of said flowable composition from said bottom dispensing package of claim 11 into said washing machine.

20. An array of laundry products comprising at least two of the bottom dispensing packages according to claim 11.
